(19) United States
(12) Patent Application Publication
(10) Pub. No.: US 2026/0032133 A1
(43) Pub. Date: Jan. 29, 2026

(54) DNS SECURITY OPERATION CENTER INSIGHTS FOR MASS SPREADING DETECTION

(71) Applicant: Infoblox Inc., Santa Clara, CA (US)

(72) Inventors: M Shadid Rashid Chowdhury, Surrey (CA); Darin Johnson, Laurel, MD (US); Naveen Singh, Santa Clara, CA (US); Adam Alexander Casella, San Jose, CA (US)

(21) Appl. No.: 18/895,178

(22) Filed: Sep. 24, 2024

Related U.S. Application Data
(60) Provisional application No. 63/675,552, filed on Jul. 25, 2024.

(51) Int. Cl. H04L 9/40

(52) U.S. Cl. CPC H04L 63/1416

(57) ABSTRACT

Various techniques for DNS security operations center insights for mass spreading detection are disclosed. In some embodiments, a system/process/computer program product for DNS security operations center insights for mass spreading detection includes collecting Domain Name System (DNS) security associated events; generating a plurality of insights based on the collected DNS security associated events, wherein at least one of the plurality of insights includes a mass spreading detection insight; and performing an action based on one or more of the insights including the mass spreading detection insight.

### CROSS REFERENCE TO OTHER APPLICATIONS

This application claims priority to U.S. Provisional Patent Application No. 63/675,552 entitled DNS SECURITY OPERATION CENTER INSIGHTS filed Jul. 25, 2024, which is incorporated herein by reference for all purposes.

### BACKGROUND OF THE INVENTION

Domain Name System network services are generally ubiquitous in IP-based networks. Generally, a client (e.g., a computing device) attempts to connect to a server(s) over the Internet by using web addresses (e.g., Uniform Resource Locators (URLs) including domain names or fully qualified domain names). Web addresses are translated into IP addresses. The Domain Name System (DNS) is responsible for performing this translation from web addresses into IP addresses. Specifically, requests including web addresses are sent to DNS servers that generally reply with corresponding IP addresses or with an error message in case the domain has not been registered, a non-existent domain.

### BRIEF DESCRIPTION OF THE DRAWINGS

Various embodiments of the invention are disclosed in the following detailed description and the accompanying drawings.

FIG. 1 illustrates a high-level architecture of a DNS security operations center (SOC) insights platform in accordance with some embodiments.

FIG. 2 illustrates example sources for a DNS SOC insights platform in accordance with some embodiments.

FIG. 3 illustrates a high-level view of a DNS SOC insights platform in accordance with some embodiments.

FIG. 4 illustrates a more detailed view of a DNS SOC insights platform in accordance with some embodiments.

FIG. 5 illustrates a screen diagram of a user interface of a DNS SOC insights platform showing raw events in accordance with some embodiments.

FIG. 6 illustrates an overview of a read performant design of a DNS SOC insights platform in accordance with some embodiments.

FIG. 7 illustrates an overview of a high-write throughput design of a DNS SOC insights platform in accordance with some embodiments.

FIG. 8 illustrates an example implementation of a scalable design of a DNS SOC insights platform through different operational metrics in accordance with some embodiments.

FIG. 9 illustrates an insights generation pipeline of a DNS SOC insights platform in accordance with some embodiments.

FIG. 10 illustrates a mass spreading detection insight provided by a DNS SOC insights platform in accordance with some embodiments.

FIG. 11 illustrates the use of a HyperLogLog for calculating a mass spreading detection insight provided by a DNS SOC insights platform in accordance with some embodiments.

FIG. 12 illustrates a priority insight provided by a DNS SOC insights platform in accordance with some embodiments.

FIG. 13 illustrates a screen diagram of an example insight provided by a DNS SOC insights platform in accordance with some embodiments.

FIG. 14 illustrates a graph database representation for an insights correlation solution provided by a DNS SOC insights platform in accordance with some embodiments.

FIG. 15 illustrates another screen diagram of an example insight provided by a DNS SOC insights platform using the insights correlation solution in accordance with some embodiments.

FIG. 16 illustrates a component diagram for providing notifications generated by a DNS SOC insights platform in accordance with some embodiments.

FIG. 17 illustrates a component diagram for providing automated responses using a DNS SOC insights platform in accordance with some embodiments.

FIG. 18 illustrates a screen diagram of an example threat actors association provided by a DNS SOC insights platform in accordance with some embodiments.

FIG. 19 illustrates an example process for an insights workflow provided by a DNS SOC insights platform in accordance with some embodiments.

FIG. 20 illustrates another example process for an insights lifecycle provided by a DNS SOC insights platform in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Domain Name System network services are generally ubiquitous in IP-based networks. Generally, a client (e.g., a computing device) attempts to connect to a server(s) over the Internet by using web addresses (e.g., Uniform Resource Locators (URLs) including domain names or fully qualified domain names (FQDNs)). Web addresses are translated into IP addresses. The Domain Name System (DNS) is responsible for performing this translation from web addresses into IP addresses. Specifically, requests including web addresses are sent to DNS servers that generally reply with corresponding IP addresses or with an error message in case the domain has not been registered, a non-existent domain (e.g., an NX Domain response is returned by DNS servers for a non-existent domain).

There exists an ever increasing number of DNS related security threats and attacks targeting enterprise networks and other DNS infrastructure.

Thus, new and improved techniques for providing DNS security operations center insights are needed.

### Overview of Techniques for DNS Security Operations Center Insights

Various techniques for DNS security operations center insights are disclosed. In some embodiments, a system/process/computer program product for DNS security operations center insights includes collecting Domain Name System (DNS) security associated events; generating a plurality of insights based on the collected DNS security associated events; and performing an action based on one or more of the insights.

In some embodiments, a system/process/computer program product for DNS security operations center insights further includes generating a mass spreading detection insight using a DNS Security Operations Center (SOC) insights platform.

In some embodiments, a system/process/computer program product for DNS security operations center insights further includes generating a notification that includes aggregated events and insights over a predetermined period of time.

For example, the disclosed techniques for DNS security operations center (SOC) insights include the following:
(1) automatically generating a SOC incident from DNS data;
(2) correlating DNS data to SOC insights;
(3) automating address of insights at a DNS level;
(4) providing an alerting mechanism and facilitating integration with different SIEMS; and
(5) automatically prioritizing DNS SOC alerts.

Thus, new and improved techniques for applying natural language processing as features for DNS tunneling detection are disclosed.

### Example System Embodiments for DNS Security Operations Center Insights

Example system embodiments for DNS security operations center insights are further described below.

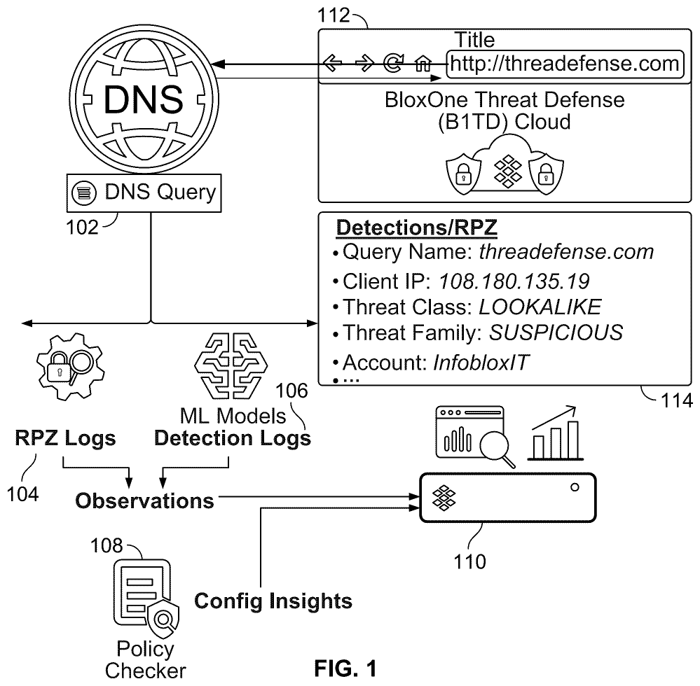

FIG. 1 illustrates a high-level architecture of a DNS security operations center (SOC) insights platform in accordance with some embodiments. The disclosed DNS SOC insights platform is highly configurable, scalable, provides for a high write throughput, and is read performant, such as will be further described below with respect to various embodiments.

For example, the disclosed DNS SOC insights platform can provide various reports and/or other information (e.g., alerts, dashboards, etc.) that facilitate users (e.g., enterprise customers) being able to identify, monitor, and analyze threat actors and their activities on their networks thereby reducing the mean-time-to-respond (MTTR) to potential risks with precise, actionable intelligence. It correlates data from multiple sources, such as remote domains, unique WHOIS data, IP addresses, domain registrars, and malware families, to detect patterns of malicious activity. SOC Insights provides customers with insights into potential targeted attacks by providing monitoring of malicious activity and offering recommended actions to mitigate the threats. This helps in detecting and mitigating potential threats related to malware and data exfiltration.

Specifically, the disclosed DNS SOC insights platform can help customers identify malicious actors that interact with multiple protected assets/users. The disclosed DNS SOC insights platform can detect organized attackers who have compromised networks by correlating multiple communications with the same source (e.g., to provide customers with insights into targeted attacks and recommend actions to block known and unknown malicious domains, monitor for malware and data exfiltration, and identify common application patterns), such as will be further described below.

Referring to FIG. 1, DNS query activity 102, such as using a cloud-based DNS security solution 112 (e.g., using the commercially available BloxOne Thread Defense (B1TD) Cloud solution that is commercially available from Infoblox Inc., headquartered in Santa Clara, CA) and RPZ logs 104 are monitored using the DNS SOC insights platform including various machine learning (ML) detection models as shown at 106 to generate various observations (e.g., example detections can include detection of malware based on suspicious queries, such as the lookalike threat class as shown at 114). A policy checker 108 can be applied to the observations to generate, for example, a configuration recommendation or other recommended actions as shown at 110. For example, the disclosed DNS SOC insights platform can provide various configuration insights and/or security insights.

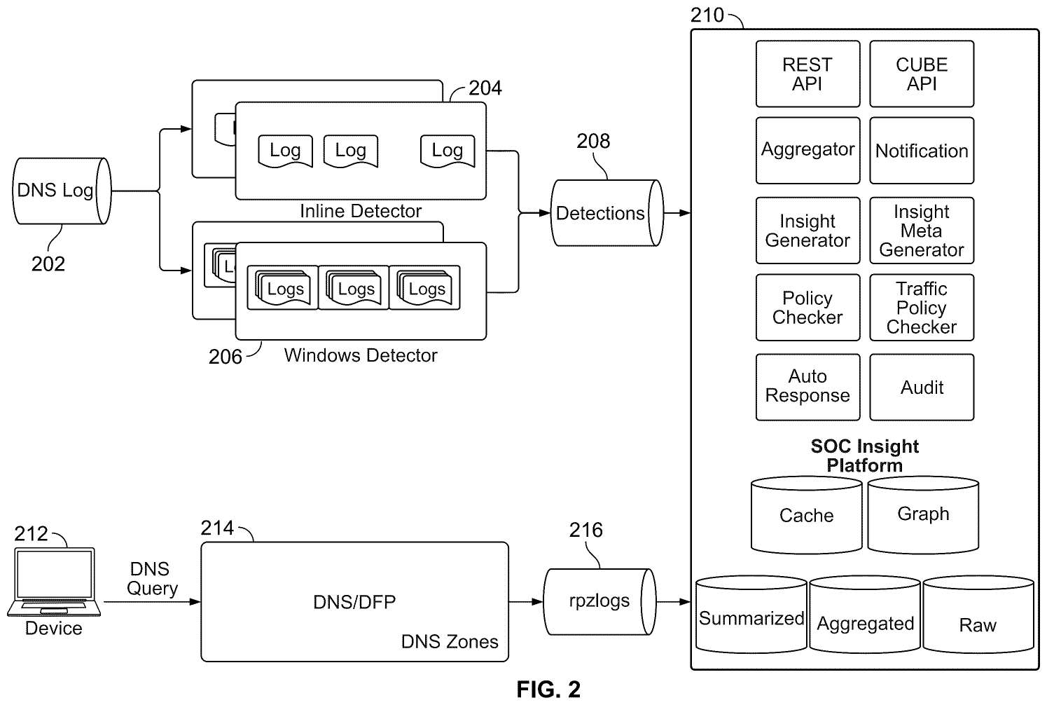

FIG. 2 illustrates example sources for a DNS SOC insights platform in accordance with some embodiments. In this example implementation, various sources for the DNS SOC insights platform are provided and further described below.

Referring to FIG. 2, DNS log data 202 are analyzed using various DNS detectors (e.g., for inline DNS security analysis), including an inline detector 204 (e.g., using raw DNS logs) and a windows detector 206 (e.g., using time-based windows of DNS logs, such as include DNS event log data, which can be stored in a data store, such as a document-based database, such as using an open source data store solution such as Elasticsearch or Solr). For example, one or more of the DNS detectors can be implemented using various heuristics and/or machine learning techniques (MLT), such ML-based classifiers for detecting various DNS anomalies, such as DNS activity associated with a data exfiltration attack, which can be implemented using inline and windows detectors, to provide detections as shown at 208. The detections can then be provided to the DNS SOC insights platform 210 as shown.

In an example implementation, various insight detectors are provided for the DNS SOC insights platform. For example, ML detectors can be provided based on machine learning, such as for performing DNS security detection based on raw DNS events (e.g., ML detectors can be provided for detecting DNS tunneling (DNST), DGA, DNS related data exfiltration, etc.). In addition, ML/algorithm-based detectors can be generated using, for example, (semi-)supervised learning techniques on raw DNS queries, and in some example implementations, can be primarily based on rules and signatures for patterns associated with DNS network traffic (e.g., ML/algorithm-based detectors can be provided for detecting major threats, botnet discovery outliers, lookalike domain threats, spear phishing, NXdomains, open DNS resolvers, etc.). Further, RPZ algorithm-based detectors can be generated using classification for DNS security matches, such as various domain-based classifications (e.g., RPZ algorithm-based detectors can be provided for detecting C2 malware, C2 download malware, phishing, compromised hosts, compromised domains, sinkholed domains, etc.).

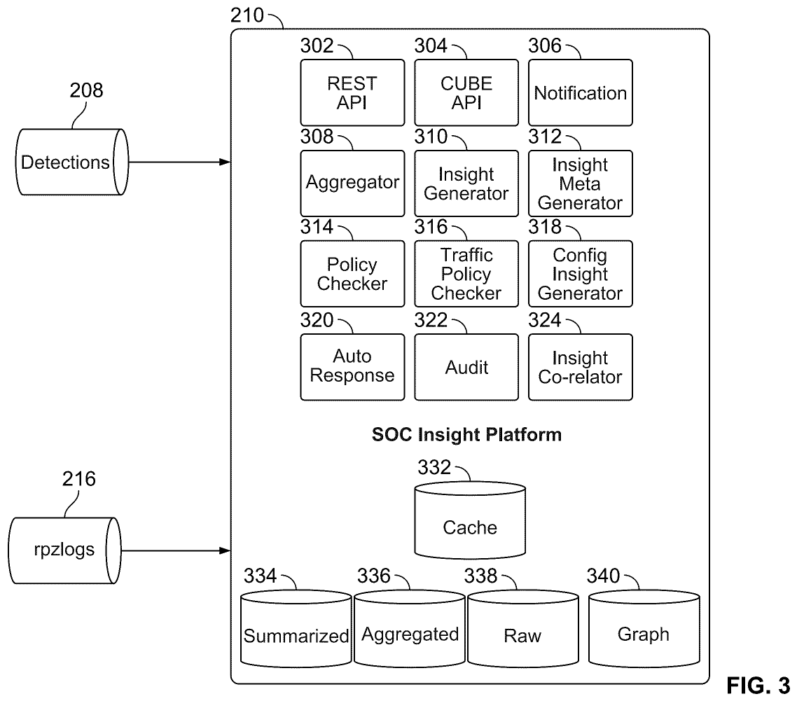

As also shown in FIG. 2, DNS query data 212 are also collected via a DNS/DNS Forwarding Proxy (DFP) 214 to capture rpzlogs 216 (e.g., for DNS security analysis, which can capture DNS feeds based on DNS zones and/or other DNS related policies (e.g., the DNS feeds can be used to generate new DNS rules/policies, and/or security expert handcrafted DNS rules/policies), which can include allowing or blocking DNS based on zones, such as countries, e.g., DNS queries to domains based in Russia can be blocked and/or logged for further analysis), that can then be provided to the DNS SOC insights platform 210 as shown and as will now be further described below with respect to FIG. 3.

FIG. 3 illustrates a high-level view of a DNS SOC insights platform in accordance with some embodiments. In this example implementation, various components of the DNS SOC insights platform are provided and further described below. As will now be described, the disclosed DNS SOC insights platform receives detections 208 and rpzlogs 208 for processing and generating of insights, which can be identified based on the aggregated and correlated data, stored, and presented in various forms (e.g., notifications/alerts, reports, dashboards, etc., as further described herein).

Referring to FIG. 3, the DNS SOC insights platform 210 includes various APIs, including REST API 302 (e.g., for communicating and/or filtering data from/to the SOC insights platform and one or more other platforms/services, etc.) and CUBE API 304 (e.g., for a user interface for the SOC insights platform, as Cubes can be used to add additional dimensions to the reports, queries, or aggregated attributes, in which the CUBE API is used to programmatically fetch data), as well as various components and data stores as will now be described below.

As shown in FIG. 3, the SOC insights platform includes a plurality of data stores that can store, in some cases, the same data in distinct formats. Specifically, a cache 332 is provided for a caching the data. A summarized data store 334 is provided for storing summarized formats of the data (e.g., summarized data are low cardinality aggregated data used to generate insights). An aggregated data store 336 is provided for storing aggregated formats of the data (e.g., high cardinality aggregated data, such as aggregations of the data across an enterprise customers set of thousands or millions of devices). A raw data store 338 is provided for storing the raw data (e.g., DNS event log data that can be implemented using a document-based database using a commercially/publicly available solution, such as ElasticSearch or other document-based database solutions can be used). A graph data store 340 is provided for storing a graph database version of the data (e.g., the graph database can facilitate storing relationships between various indicators/insights, etc., which can be implemented using a publicly/commercially available graph database, such as Neptune available from Amazon Web Services or other graph-based database solutions can be used).

As also shown in FIG. 3, the SOC insights platform includes a plurality of components. Specifically, a notification component 306 is provided for generating notifications based on the DNS SOC insights (e.g., alerts, and/or other notifications can be generated). An aggregator component 308 is provided for aggregating the data, including detections 208 and rpzlogs 216. An insight generator component 310 is provided for generating insights based on the aggregated data. An insight meta generator component 312 is provided for generating higher-level (e.g., meta) insights based on the aggregated data (e.g., meta level insights can be triggered based on insights for events that exceed a predetermined or context dependent dynamic threshold, such as a mass spreading event, such as will be further described below). A policy checker component 314 is provided for verifying policies (e.g., DNS security policies/rules) for errors, misconfigurations, and/or other issues (e.g., based on a static analysis of such policies). A traffic policy checker component 316 is provided for also verifying policies (e.g., DNS security policies/rules) for errors, misconfigurations, and/or other issues (e.g., based on a dynamic traffic analysis, such as to determine that certain DNS traffic was not blocked and did not hit any of your configured policies but the DNS traffic was a query for a domain that is a known malware domain in a malware domain feed, so the traffic policy checker can identify such as a policy misconfiguration as that malware domain feed should be included in the configured policy to hit and block such queries). A configuration insight generator component 318 utilizes the results from the policy checker 314 and traffic policy checker 316 to automatically generate the configuration insights. An automated response component 320 is provided to facilitate automating responses based on insights, such as event-based insights, configuration insights, notifications, etc., for users of the SOC insights platform (e.g., a user can utilize the auto response to add a rule to automatically block a given domain based on a notification that it is a lookalike malicious domain). An audit component 322 is provided to facilitate auditing of various actions on the SOC insights platform (e.g., audit what domains are added to a block list based on a selected auto response action, such as which domains were automatically added to a block list, etc.). Finally, an insight correlator component 324 is provided for automatically correlating the various insights, such as will be further described below.

In various embodiments, the SOC insights platform is implemented as a cloud-based service.

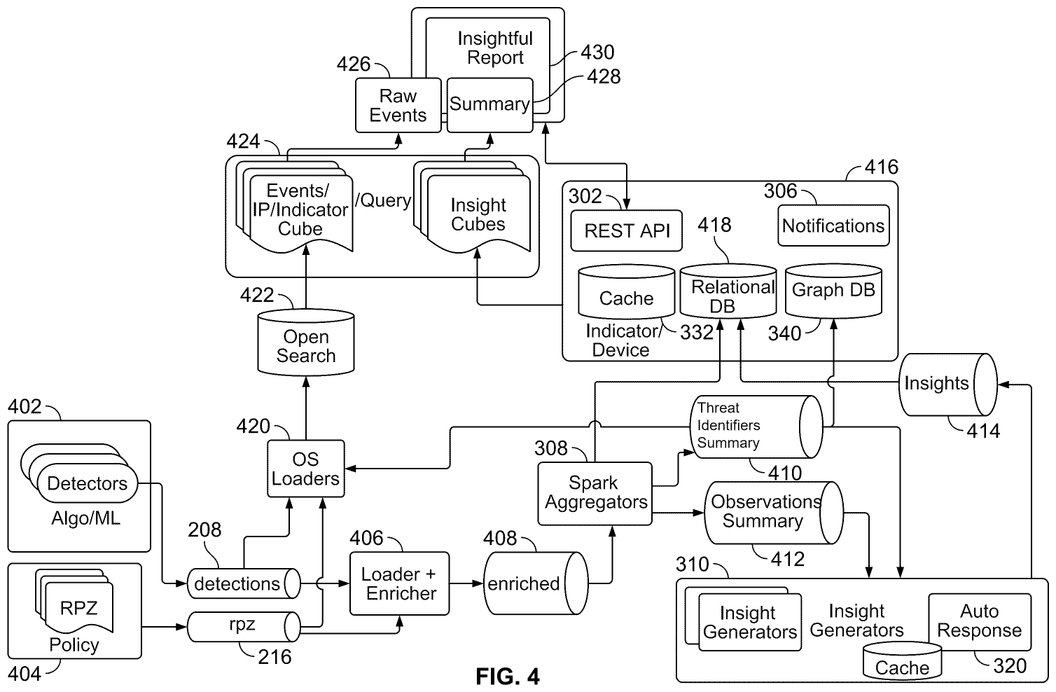

FIG. 4 illustrates a more detailed level view of a DNS SOC insights platform in accordance with some embodiments. In this example implementation, various components of the DNS SOC insights platform are provided as similarly described above and including the data flows between the above-described components of the DNS SOC insights platform. In this example implementation, various components the DNS SOC insights platform are provided and further described below. As will now be described, the disclosed DNS SOC insights platform receives detections 208 from detectors 402 (e.g., a plurality of different DNS security related detectors, such as for detecting lookalike malicious domains, command and control (C2) related domains, DNS tunneling activity, etc., which can be machine learning (ML) implemented models/classifiers, or implemented using heuristics, signatures, and/or other techniques) and rpzlogs 216 from policy/RPZ 404 (e.g., for DNS security policy related hits/matches) for processing and generating of insights, which can be identified based on the aggregated and correlated data, stored, and presented in various forms (e.g., notifications/alerts, reports, dashboards, etc., as further described herein).

Referring to FIG. 4, the disclosed DNS SOC insights platform receives detections 208 from detectors 402 and rpzlogs 208 from policy/RPZ 404 for processing and enriching as shown at 406 and 408. Examples of enrichment can include adding geolocation information associated with IP numbers for the DNS related traffic activity as well as various other forms of enrichment, such as network, device (e.g., device ID), threat actor (e.g., threat actor ID for the attacker associated with creation of a malicious domain, etc.), and/or other meta information. This enriched data is then fed into two different data processing channels from aggregators 308 (e.g., can be implemented using publicly available data processing framework like Apache Spark, Flink which provides a unified engine for large-scale data analytics, and is publicly available at https://spark.apache.org/, or another commercially/publicly available data analytics engine can similarly be used) as shown in FIG. 4. The aggregated data is then fed through an indicator/device component, shown as threat identifiers summary 410 and an observations summary component 412 and then into the Insights generators 310 for automatically generating various insights 414 (e.g., based on different logic and thresholds, such as described herein) as shown. The insights 414 are then fed into an Insightful Service 416 along with the enriched data from the aggregators 308 as well as the threat identifiers summary data 410 as also shown. In this example implementation, the Insightful Service 416 is implemented as a message streaming platform using a global-scale relational databased shown as an Aurora Postgres 418 (e.g., a cloud-based MySQL and PostgresSQL compatible data storage solution that is commercially available from Amazon Web Services (AWS)-Amazon Aurora, or another commercially/publicly available data storage solution can similarly be used) for storing the insights. The REST API 302 facilitates communications (e.g., alerts, notifications, report generation, etc.) with a user interface (UI) provided using an Insightful Report component 430.

As also shown in FIG. 4, the Open Search (OS) loaders 420 (e.g., implemented using ElasticSearch or another commercially/publicly available document-based search solution can similarly be used) as the received data from detections 208 from detectors 402 and rpzlogs 208 from policy/RPZ 404 is stored in the Open Search data store 422. In this example implementation, various queries can be performed, such as using Cube API 304, as shown at 424 to provide relevant raw events 426 and/or a summary 428 to present to the UI/Insightful Report 430 as shown.

### DNS SOC Insights Platform: Read Performant, High-Write Throuput, and Scalable

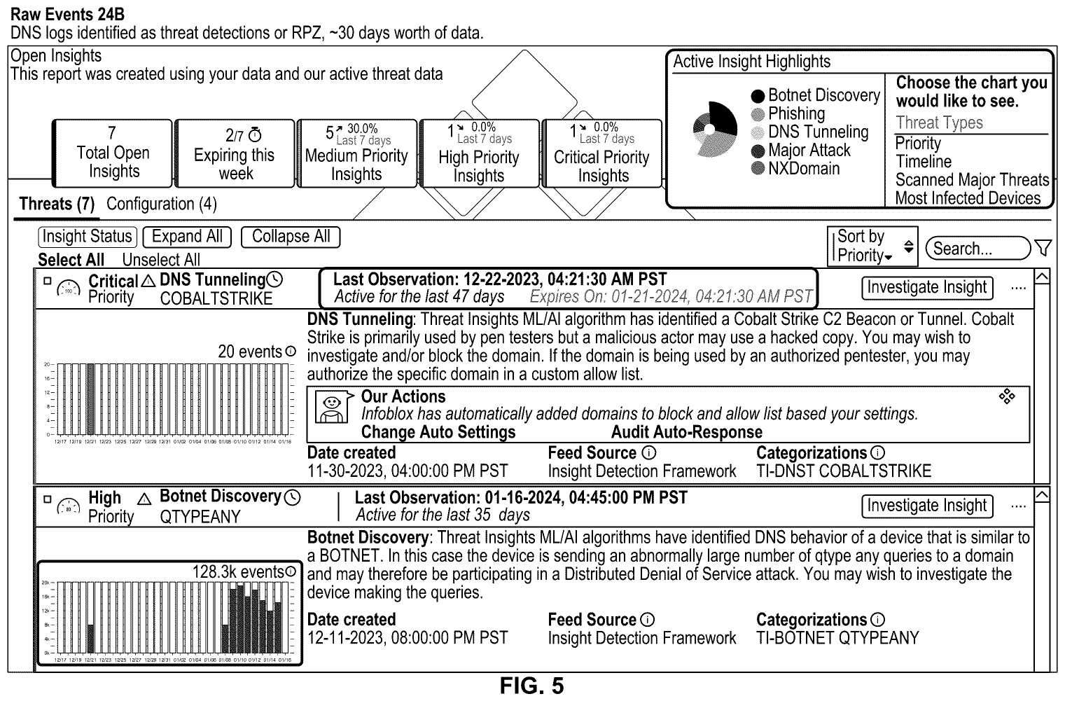

FIG. 5 illustrates a screen diagram of a user interface of a DNS SOC insights platform showing raw events in accordance with some embodiments. Specifically, FIG. 5 illustrates a screen diagram showing DNS logs identified as threat detections or RPZ for approximately 30 days of data (e.g., 24 billion (B) events as shown in this example). This raw events volume of data illustrates a need to make the DNS SOC insights platform that is a read performant solution, such as will be further described below.

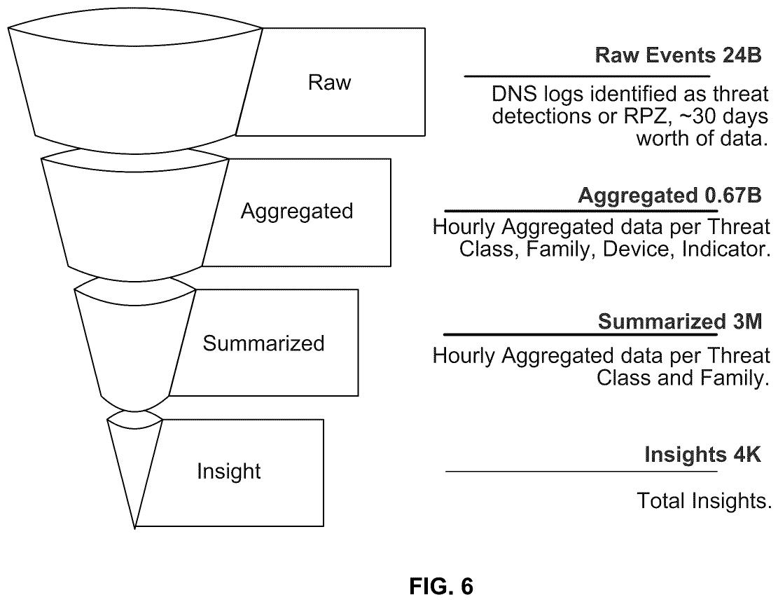

FIG. 6 illustrates an overview of a read performant design of a DNS SOC insights platform in accordance with some embodiments. As shown, the raw events data (e.g., 24B events for a 30-day period of time) is aggregated, for example, hourly aggregation per threat class, family, device, and indicator (e.g., into a total of 0.67B events), which is then summarized, for example, hourly aggregated data per threat class and family (e.g., into 3 million (M) events), which is then utilized for generating insights using the DNS SOC insights platform (e.g., for 4 thousand (K) insights) as shown in this example. In this example implementation, data is read in multiple phases from insights to raw events as SOC operators investigate an insight. Also, read queries are directed to read replicas only to isolate from write traffic. Read replicas are utilized for scaling and making read performant design of the DNS SOC insights platform. Further, aggregated materialized view is used to pre-process and join relevant data for read efficiency.

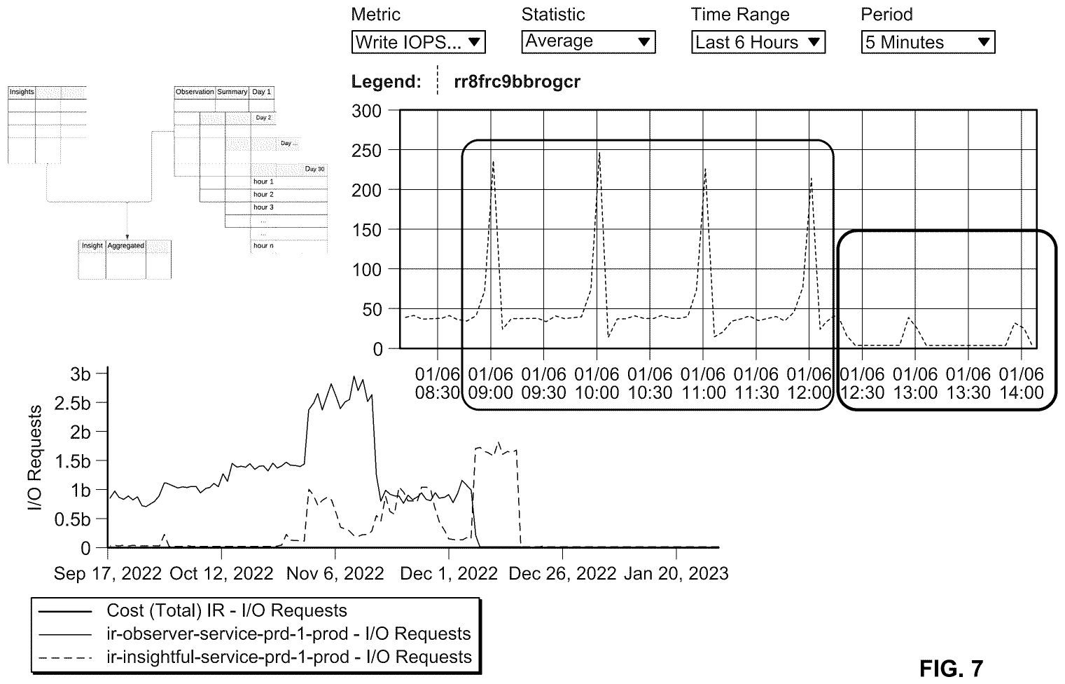

FIG. 7 illustrates an overview of a high-write throughput design of a DNS SOC insights platform in accordance with some embodiments. In this example implementation, we show how data modelling is designed to avoid any updates and instead supports append only pattern to achieve high write throughput. Partitions of the data (e.g., 1-day of write data partitions) can be utilized for the high-write throughput design of the DNS SOC insights platform.

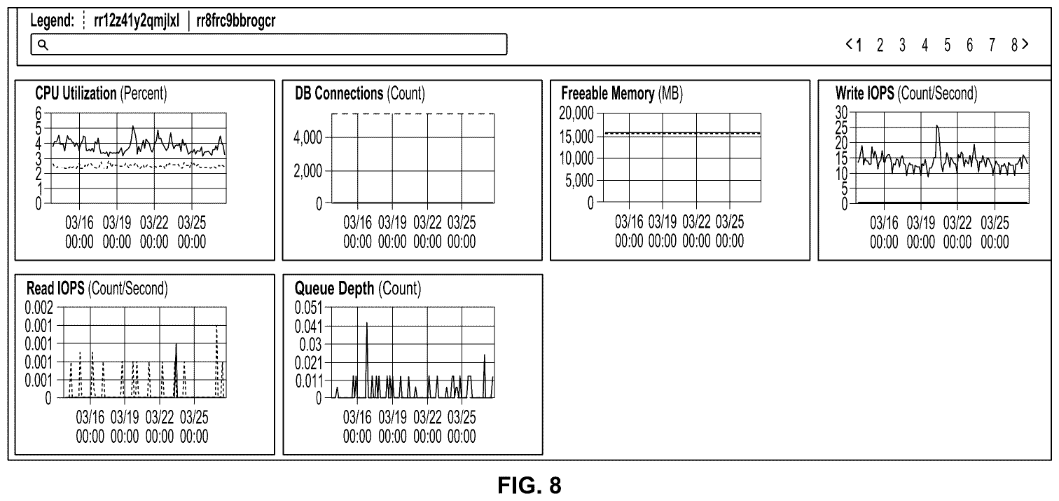

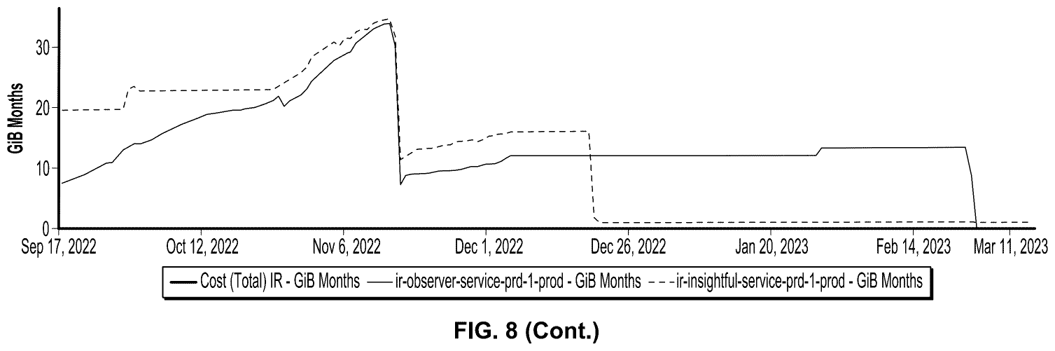

FIG. 8 illustrates an example implementation of a scalable design of a DNS SOC insights platform through different operational metrics in accordance with some embodiments. In this example implementation, given the large volumes of the received, aggregated, and annotated data, the data can be maintained for a limited period of time (e.g., 30-days of the data, and efficiently removing partitions of data that are past the predetermined period of time, rather than using CPU cycles to erase/overwrite the previously stored data in such partitions) to facilitate the scalable design of the DNS SOC insights platform.

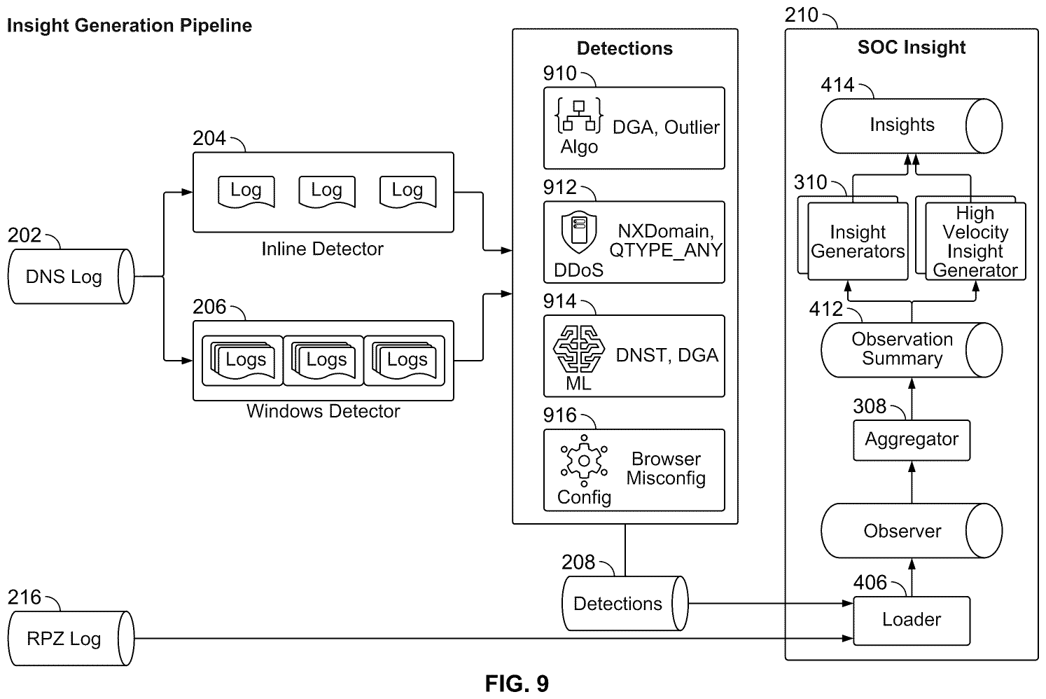

FIG. 9 illustrates an insights generation pipeline of a DNS SOC insights platform in accordance with some embodiments. Specifically, FIG. 9 illustrates the various DNS security detection techniques that can be utilized in the insights generation platform as similarly described above.

Referring to FIG. 9, as shown in this example implementation of the insights generation platform, the various detections include a domain generation algorithm (DGA) detector detects randomly generated domains often used for malicious intent 910, an NXDomain detector detects high volume of invalid domains 912, and DNS tunneling (DNST) detects data exfiltration attempt through generating a DNS tunnel by an attacker and DGA detector 914, and a browser misconfiguration detector, which detects large volume invalid DNS queries generated due to browser/tool misconfigurations 916.

### DNS SOC Insights Platform: Mass Spreading, Priority, Insight Correlation, Notifications, Auto Response, and Actors

In some embodiments, the disclosed DNS SOC insights platform includes various techniques for identifying mass spreading events, priority events, insight correlation, notifications, automated (auto) responses, and/or identification of actors (e.g., threat actors). Each of these techniques will now be further described below.

In an example implementation, the disclosed DNS SOC insights platform can generate insights per threat class and threat family. This facilitates a reduction in noise but aggregating such insights into groupings by threat class and/or threat family. Moreover, such is more efficient for users of the DNS SOC insights platform as such can generally be resolved/remedied similarly if in the same threat class and/or threat family.

In an example implementation, the disclosed DNS SOC insights platform can generate insights classified into high risk (e.g., a single threat actor), high velocity (e.g., based on an hourly or other predetermined time related threshold), and/or RPZ (e.g., adding to a watch list for a predetermined period of time, such as 5 days, etc.).

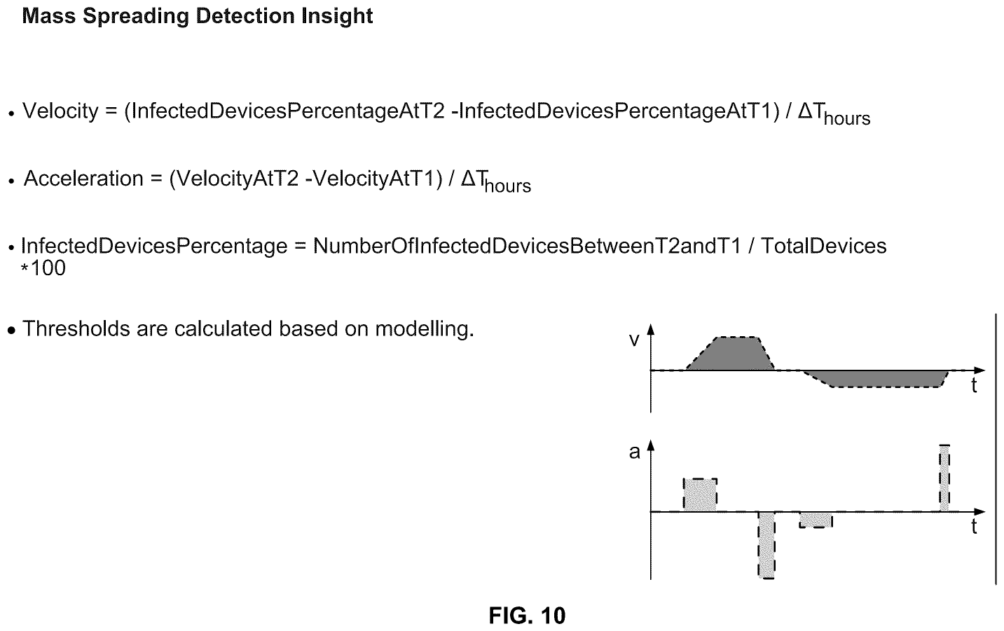

FIG. 10 illustrates a mass spreading detection insight provided by a DNS SOC insights platform in accordance with some embodiments. Specifically, FIG. 10 illustrates an example implementation of a mass spreading detection technique and insights that can be utilized in the insights generation platform as similarly described above.

Referring to FIG. 10, in this example implementation, a velocity metric for a DNS security related spreading event is calculated as follows: (a number of infected devices by percentage at a time T2 subtracted by a number of infected devices by percentage at a time T1) divided by the delta/change in time (e.g., in hours).

An acceleration metric for a DNS security related spreading event is calculated as follows: (a velocity at time T2 minus a velocity at time T1) divided by the delta/change in time (e.g., in hours).

The infected devices percentage metric for a DNS security related spreading event is calculated as follows: (a number of infected devices between a time T1 and a time T2) divided by (the total number of devices multiplied by 100).

As such, these mass spreading related thresholds can then be calculated based on modeling, such as shown in the example graphs illustrated in FIG. 10.

Also, these mass spreading events can be configured based on thresholds. For example, if 5 devices are infected for an enterprise that has only a total of 10 devices on their enterprise network, then this can trigger a percentage based threshold of greater than 20% of the devices being infected.

However, there exist various technical challenges with performing the above-described mass spreading event determinations. First, calculating a distinct count/sum of a multiset may not be feasible. Second, aggregated counts may not be additive. Third, computation costs associated with high cardinality dimensions can be expensive.

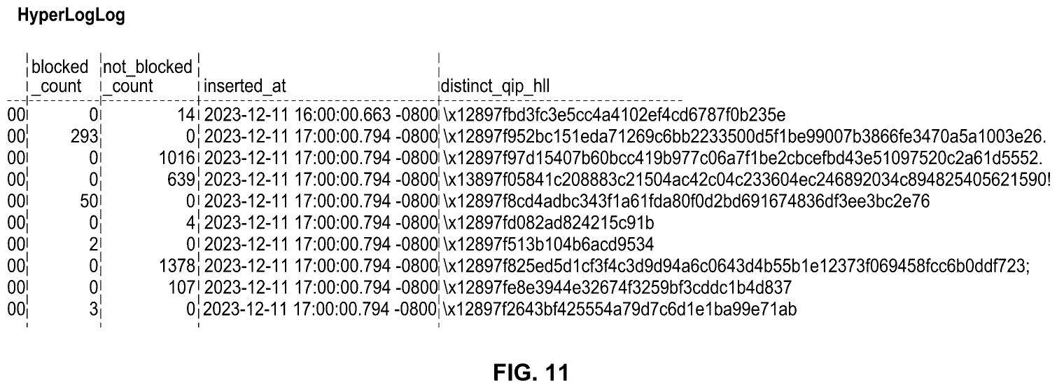

FIG. 11 illustrates the use of a HyperLogLog for calculating a mass spreading detection insight provided by a DNS SOC insights platform in accordance with some embodiments. Specifically, FIG. 11 illustrates an example implementation of a mass spreading detection technique and insights that utilize a HyperLogLog for performing these mass spreading related calculations as further described below.

For example, HyperLogLog (e.g., a publicly available library, see, e.g., https://github.com/axiomhq/hyperloglog) is a probabilistic data structure that estimates the cardinality of a set (e.g., applied in this example implementation, for approximating the number of distinct devices that have been infected over a period of time to also address the additive problem described above). HyperLogLog is a probabilistic data structure that estimates the cardinality of a set. As a probabilistic data structure, HyperLogLog trades perfect accuracy for efficient space utilization. As such, HyperLogLog can be applied to address the above-described computational costs associated with high cardinality dimensions.

As another example, for mass spreading related processing, we consider total unique devices in comparison with devices infected, infection velocity, and/or other factors. Devices can be a high cardinality dimension for many large organizations. Calculating unique device percentage, infection velocity for a configurable time can be very expensive and time consuming. As such, Hyperloglog can be applied to reduce the compute time for such mass spreading related processing.

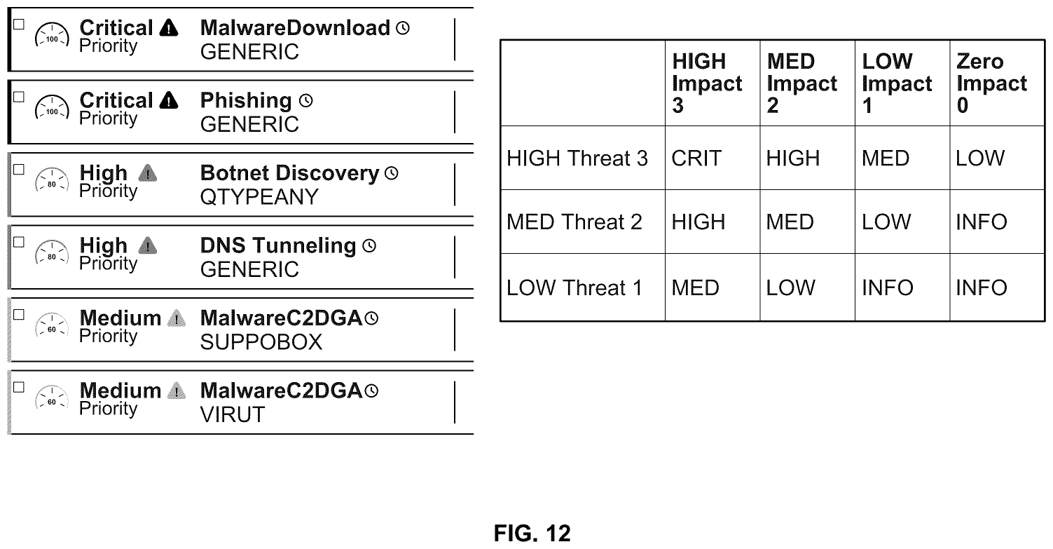

FIG. 12 illustrates a priority insight provided by a DNS SOC insights platform in accordance with some embodiments. Specifically, FIG. 12 illustrates an example implementation of a priority detection techniques and insights that can be utilized in the insights generation platform as similarly described above.

Referring to FIG. 12, in this example implementation, the priority insight can be based on an impact and the threat associated with the DNS related event/detection, as well as actionability can be provided with such a priority insight as will now be further described. For each DNS level log and for each DNS indicator, a confidence level and a threat level are provided.

In this example implementation, the priority is calculated by the sum of threat and the impact. Specifically, the threat calculation is determined from the maximum value of the threat level and maximum value of the confidence level/score (e.g., on a scale of 0 to 100) of all indicators associated with an insight(e.g., if confidence is low, then low; if confidence is high, then value of the threat level). The impact calculation is based on whether it is a mass spreading event (e.g., as similarly described above with respect to FIGS. 10 and 11) and persistent (e.g., referring to how often it is observed, such as daily for last 30 days would indicate a persistent event) (e.g., if it is a mass spreading event, then it is allocated a high impact value of 3; if it is a persistent event but not mass spreading, then it is allocated a medium impact value 2; otherwise, it is allocated a low impact value 1). Finally if the unblocked query count is equal to 0, then the impact value is reduced by 1; and if the unblocked query count is greater than 0, then increase the impact is increased by 1.

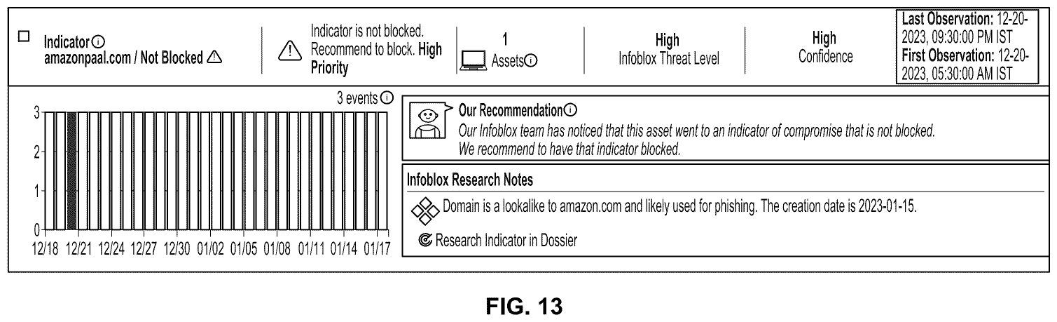

FIG. 13 illustrates a screen diagram of an example insight provided by a DNS SOC insights platform in accordance with some embodiments. Specifically, FIG. 13 illustrates an example implementation of a user interface for showing insights that can be generated using the insights generation platform as similarly described above.

Referring to FIG. 13, in this example implementation, the insights correlation can be applied for a detected indicator that was added to a different RPZ class and blocked. In this example, the domain indicator was amazonpall.com that was subsequently determined to be a lookalike malicious domain likely used for phishing, which should be blocked (e.g., as shown, with a high threat level and high confidence, with one asset impacted). Specifically, FIG. 13 illustrates an example of the insights correlation technical challenge as the example phishing domain not being blocked can be a result of users for the tenant/enterprise not querying that amazonpall.com domain in the last monitored period of time (e.g., last 30 days) or it could be added to another DNS feed (e.g., example DNS feeds can include a C2 feed, a DNST feed, a custom feed, etc.).

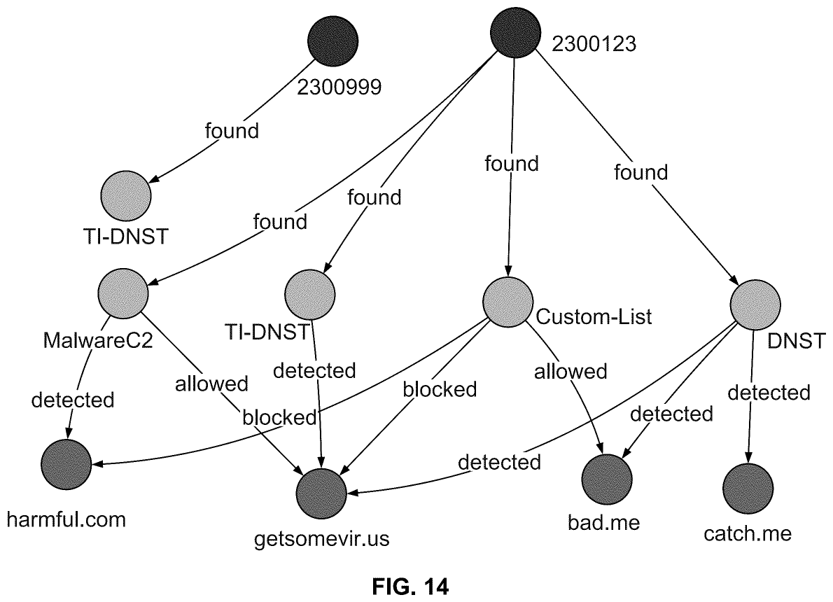

FIG. 14 illustrates a graph database representation for an insights correlation solution provided by a DNS SOC insights platform in accordance with some embodiments. Specifically, FIG. 14 illustrates an example implementation of insights correlation techniques that can be utilized in the insights generation platform as similarly described above.

Referring to FIG. 14, in this example implementation, to address the above-described insight correlation technical challenge, the above-described graph database (e.g., as shown at 340 in FIG. 3) can be utilized, such as shown in FIG. 14. As shown in the graph relationships illustrated in FIG. 4, the leaf nodes can correspond to specific DNS events, such as detecting a specific domain, in this case, amazonpaal.com, which in this example graph is represented by leaf nodes, such as the getsomevir.us leaf node. As indicated in these graph relationships, the getsomevir.us domain was found/detected, and while it was allowed/not blocked by certain feeds (e.g., malware C2, TI-DNST, and DNST feeds detected and allowed or did not block), it was detected and blocked by the at least one of the feeds (i.e., Custom-List feed) as shown.

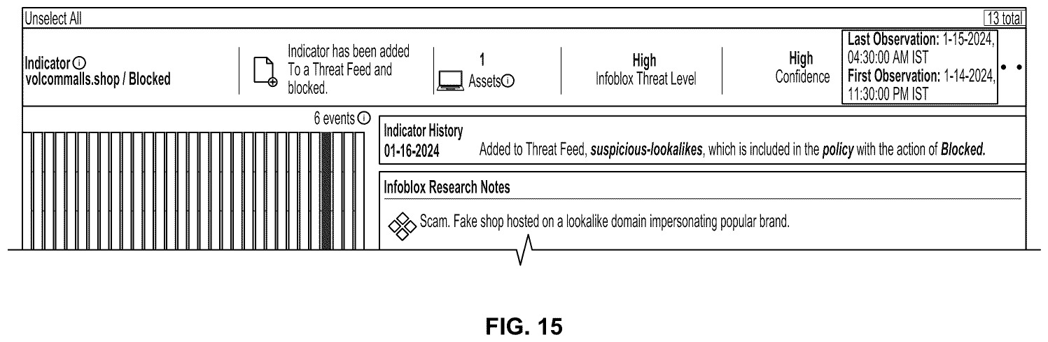

FIG. 15 illustrates another screen diagram of an example insight provided by a DNS SOC insights platform using the insights correlation solution in accordance with some embodiments. Specifically, FIG. 15 illustrates an example implementation of insights correlation techniques that can be utilized in the insights generation platform as similarly described above.

Referring to FIG. 15, in this example implementation, to address the above-described insight correlation technical challenge, the user interface for the disclosed insights correlation solution provided by the DNS SOC insights platform includes the indicator history as shown.

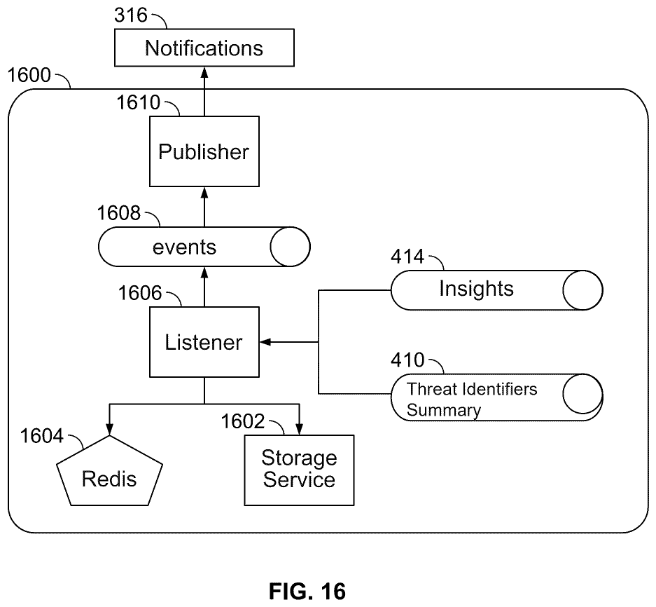

FIG. 16 illustrates a component diagram for providing notifications generated by a DNS SOC insights platform in accordance with some embodiments. Specifically, FIG. 16 illustrates an example implementation of example notification components 1600 that can be utilized in the insights generation platform as similarly described above.

Referring to FIG. 16, in this example implementation, example notification components 1600 include a storage service and a cache service 1604 (e.g., commercially/publicly available storage and Redis solutions can be utilized), a listener service 1606 that receives the above-described threat identifiers summary queue (e.g., including high cardinality data, such as device, indicator, etc.) 410 and insights 416, which are then collected and provided to an events component 1608 (e.g., example events can include a new insight, a new indicator, a new asset, etc.), which sends the events to a publisher 1610. The publisher 1610 provides these events to the above-described notifications component 316 for present to the user in various formats (e.g., alerts, reports, user interface/screen showing notifications of such events, etc.).

Specifically, the disclosed notification implementation facilitates providing relevant alerts without causing an alert fatigue (e.g., overwhelming users with too many alerts) that can result in important alerts/notifications being lost in the noise of too many alerts/notifications. For example, a notification can be provided in response to a new insight being generated, or in response to detecting a new indicator (e.g., a new domain) or detecting a new asset (e.g., a new device is infected on the enterprise network for the customer).

In this example implementation, the notifications can be grouped per hour (e.g., or another predetermined/configurable time period). As such, for a large customer, assuming that they have more than 500,000 devices in this example, a grouped hourly notification may include insights associated with 500 infected devices, which is provided in a single notification as opposed to 500 separate notification in this example. The notifications can be subcategorized, such as by insights, indicators, and devices, and/or various other subcategories can similarly be utilized. As also similarly described above, the notifications can be accessed via various other platforms/services (e.g., for computer/network/security/Information Technology (IT) management) using the above-described REST API (e.g., as shown at 302 in FIG. 3).

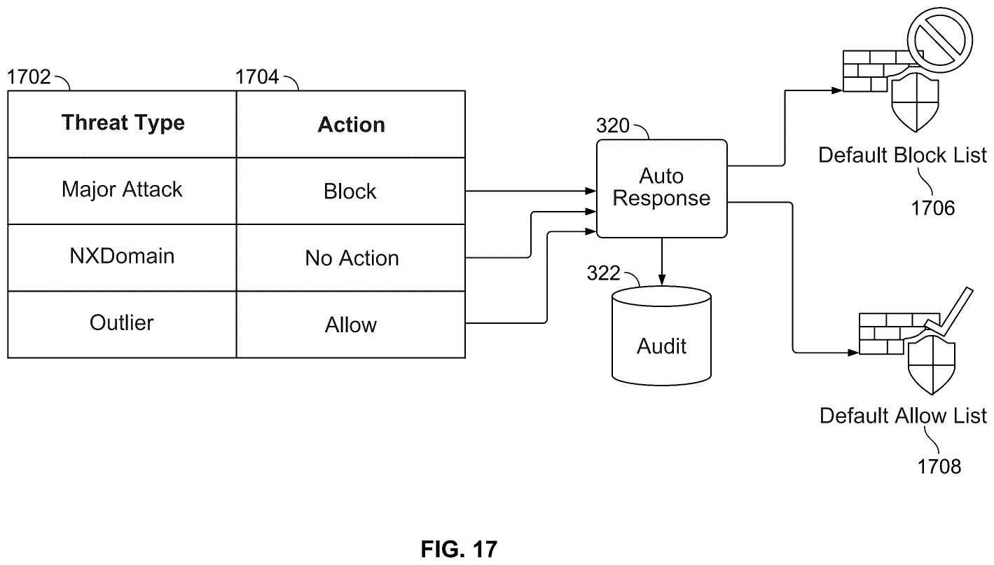

FIG. 17 illustrates a component diagram for providing automated responses using a DNS SOC insights platform in accordance with some embodiments. Specifically, FIG. 17 illustrates an example implementation of example automated response components that can be utilized in the insights generation platform to facilitate the performing of automated actions (e.g., based on configurations and/or user selections, etc.) as similarly described above.

Referring to FIG. 17, in this example implementation, example automated response components include a threat type categorization as shown at 1702, an action type categorization based on the threat type as shown at 1704, the above-described auto response component 320 (e.g., as similarly described above with respect to FIG. 3), and the above-described audit component 322 (e.g., as similarly described above with respect to FIG. 3). In this example implementation, the auto response component 320 can perform an automated action for a given threat type (1702) based on the predetermined associated action (1704) to, for example, perform a default block action as shown at default block list 1706 or to perform a default allow action as shown at 1708. These actions can be configurable by users/customers for their enterprise network to perform various actions in response to various threat types (e.g., DNS threat indicators, insights, devices being compromised/infected, and/or various other events, such as similarly described herein). The audit component (322) facilitates auditing of any automated responses/actions performed by the SOC insights platform.

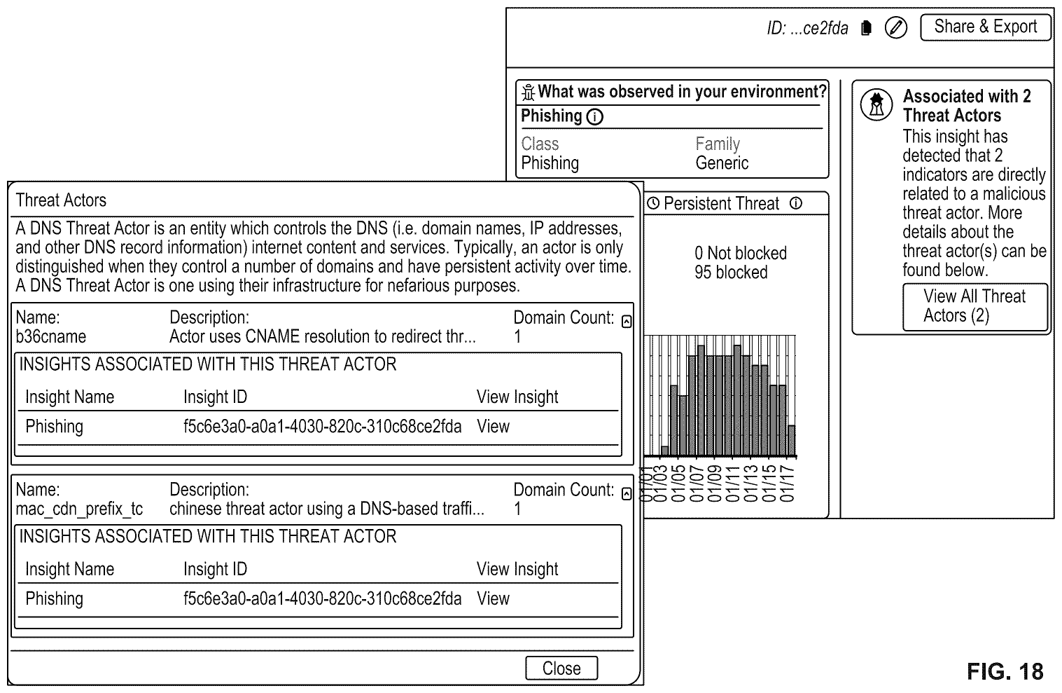

FIG. 18 illustrates a screen diagram of an example threat actors association provided by a DNS SOC insights platform in accordance with some embodiments. Specifically, FIG. 18 illustrates an example implementation of a user interface for showing an association of given threat actors that can be generated as an example insight using the insights generation platform as similarly described above.

As will now be apparent to one of ordinary skill in the art in view of the disclosed embodiments, the disclosed techniques for providing DNS security operations center insights can similarly be applied to various other DNS, networking, security, and/or other applications to provide enhanced security for enterprises and/or other entities and/or users.

Additional example process embodiments for providing DNS security operations center insights will now be further described below.

### Example Process Embodiments for DNS Security Operations Center Insights

Example process embodiments for DNS security operations center insights are further described below.

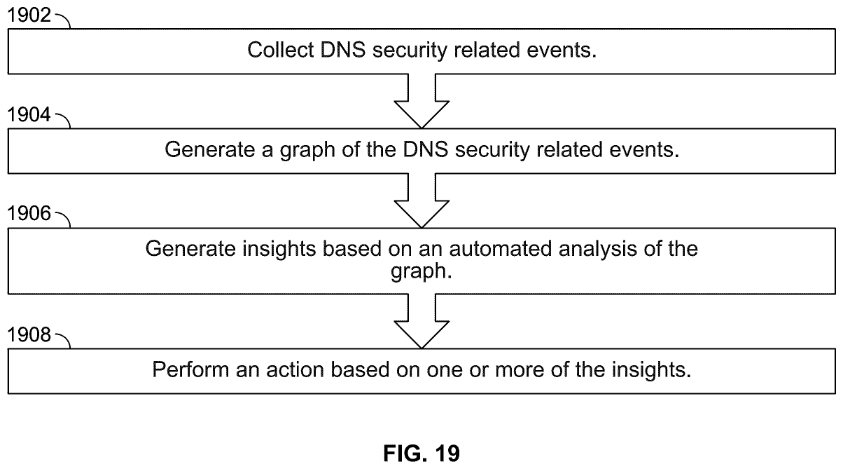

FIG. 19 illustrates an example process for an insights workflow provided by a DNS SOC insights platform in accordance with some embodiments. In some embodiments, a process as shown in FIG. 19 is performed using the DNS security operations center insights platform and techniques as similarly described above including the embodiments described above with respect to FIGS. 1-18.

At 1902, collecting DNS security related is performed, such as similarly described above. For example, such events can include DNS threat indicators, compromised/infected devices, threat actors, and/or various other events, such as similarly described above with respect to various embodiments.

At 1904, a graph is generated of the DNS security related events. For example, a graph can be generated as similarly described above with respect to FIG. 14.

At 1906, insights are generated based on an automated analysis of the graph. For example, various insights can be automatically generated as similarly described above with respect to FIGS. 3-5 and 9-15.

At 1908, an action is performed based on one or more of the insights. For example, an automated response can be performed in response to a new DNS threat, such as similarly described above with respect to FIG. 17. In some cases, the action can include providing a notification, such as similarly described above with respect to FIG. 16.

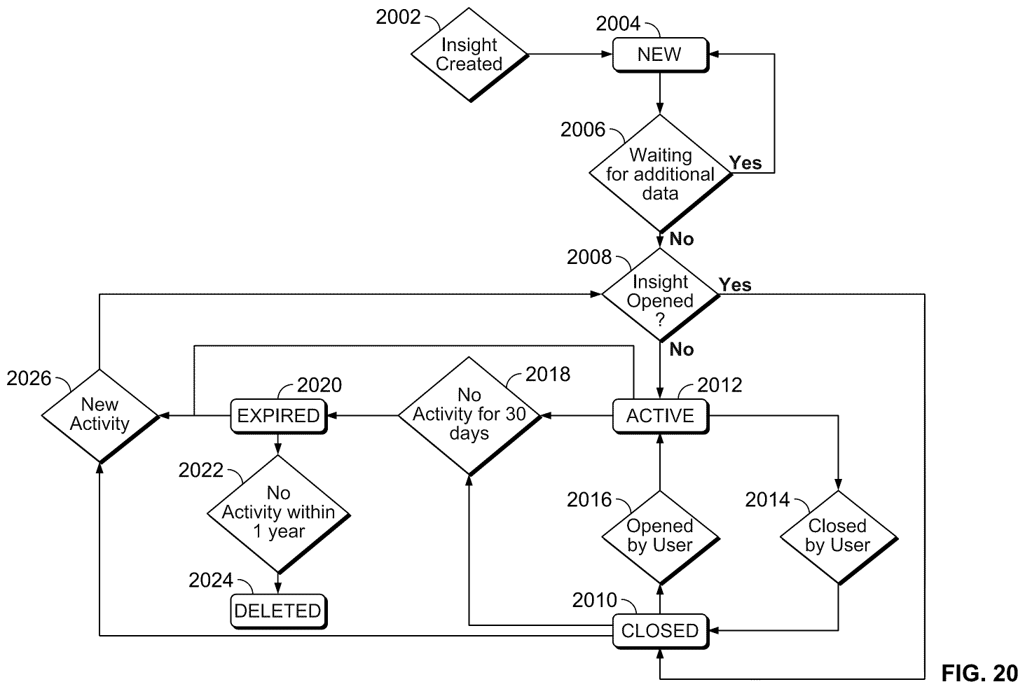

FIG. 20 illustrates another example process for an insights lifecycle provided by a DNS SOC insights platform in accordance with some embodiments. In some embodiments, a process as shown in FIG. 20 is performed using the DNS security operations center insights platform and techniques as similarly described above including the embodiments described above with respect to FIGS. 1-18.

At 2002, a new insight is created, such as similarly described above.

At 2004, whether this corresponds to a new insight is determined.

At 2006, whether the DNS SOC insights platform is waiting for additional information associated with the new insight is determined. If so, processing returns to 2004 to collect the additional information for the new insight.

Otherwise (e.g., if not), processing proceeds to 2008, at which it is determined whether a new insight is opened. If so, the processing proceeds to stage 2010.

Otherwise (e.g., if not), processing proceeds to 2012 to determine whether it is an active insight.

At 2014, it is determined whether the insight has been closed by a user of the DNS SOC insights platform, and if so, then processing proceeds to 2010.

At 2016, it is determined whether the closed insight have been opened by a user of the DNS SOC insights platform, and if so, processing reverts to 2012.

At 2018, it is determined whether there has been no further relevant activity to the insight in the last 30 days (e.g., or another predetermined/configurable time period can similarly be used).

At 2020, if there has been no such further activity over the last 30 days, then the insight is deemed expired.

At 2022, if there has been no such further activity over the last one year (e.g., or another predetermined/configurable time period can similarly be used), then the insight is deleted as shown at 2024.

At 2026, whether there has been new activity relevant to the previously expired (2020) or closed (2010) insight is determined, and if so, the insight is opened as shown at 2008 and processing can proceed from stage 2008 as similarly described above.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a processor configured to:
collect Domain Name System (DNS) security associated events;
generate a plurality of insights based on the collected DNS security associated events, wherein at least one of the plurality of insights includes a mass spreading detection insight; and
perform an action based on one or more of the insights including the mass spreading detection insight; and
a memory coupled to the processor and configured to provide the processor with instructions.

2. The system recited in claim 1, wherein the plurality of insights is automatically generated based on aggregated DNS security associated events using a DNS Security Operations Center (SOC) platform.

3. The system recited in claim 1, wherein the plurality of insights are automatically generated and correlated based on aggregated DNS security associated events using a DNS Security Operations Center (SOC) platform, and wherein the DNS SOC platform receives the DNS security associated events from a plurality of DNS security related detectors.

4. The system recited in claim 1, wherein the plurality of insights is automatically generated based on aggregated DNS security associated events using a DNS Security Operations Center (SOC) platform, wherein the DNS SOC platform receives the DNS security associated events from a plurality of DNS security related detectors, and wherein the DNS SOC platform includes an insights pipeline.

5. The system recited in claim 1, wherein the mass spreading detection is based on a configurable threshold for a DNS security related spreading event.

6. The system recited in claim 1, wherein the mass spreading detection is based on an acceleration metric for a DNS security related spreading event.

7. The system recited in claim 1, wherein the processor is further configured to:
generate a mass spreading detection insight using a DNS Security Operations Center (SOC) insights platform.

8. The system recited in claim 1, wherein the processor is further configured to perform the following action in response to identification of a detected malicious domain:
automatically block the malicious domain.

9. The system recited in claim 1, wherein the processor is further configured to perform the following action in response to identification of a domain generation algorithm (DGA) attack:
block the DGA attack at a DNS security platform using a DNS Security Operations Center (SOC) insights platform.

10. The system recited in claim 1, wherein the processor is further configured to perform the following action in response to identification of a DNS tunneling (DNST) attack:
block the DNST attack at a DNS security platform using a DNS Security Operations Center (SOC) insights platform.

11. The system recited in claim 1, wherein the processor is further configured to perform the following action in response to identification of a command and control (C2) attack:
block the C2 attack at a DNS security platform using a DNS Security Operations Center (SOC) insights platform.

12. The system recited in claim 1, wherein the processor is further configured to perform the following action in response to identification of a DNS data exfiltration attack:
block the DNS data exfiltration attack at a DNS security platform using a DNS Security Operations Center (SOC) insights platform.

13. The system recited in claim 1, wherein the processor is further configured to perform the following action in response to identification of a phishing attack:
block the phishing attack at a DNS security platform using a DNS Security Operations Center (SOC) insights platform.

14. The system recited in claim 1, wherein the processor is further configured to perform the following action in response to identification of a spear phishing attack:
block the spear phishing attack at a DNS security platform using a DNS Security Operations Center (SOC) insights platform.

15. A method, comprising:
collecting Domain Name System (DNS) security associated events;
generating a plurality of insights based on the collected DNS security associated events, wherein at least one of the plurality of insights includes a mass spreading detection insight; and
performing an action based on one or more of the insights including the mass spreading detection insight.

16. The method of claim 15, wherein the plurality of insights is automatically generated based on aggregated DNS security associated events using a DNS Security Operations Center (SOC) platform.

17. The method of claim 15, wherein the mass spreading detection is based on a configurable threshold for a DNS security related spreading event.

18. The method of claim 15, wherein the mass spreading detection is based on an acceleration metric for a DNS security related spreading event.

19. The method of claim 15, further comprising:
generating a mass spreading detection insight using a DNS Security Operations Center (SOC) insights platform.

20. A computer program product embodied in a non-transitory computer readable medium and comprising computer instructions for:
collecting Domain Name System (DNS) security associated events;
generating a plurality of insights based on the collected DNS security associated events, wherein at least one of the plurality of insights includes a mass spreading detection insight; and
performing an action based on one or more of the insights including the mass spreading detection insight.
